(19) United States
(12) Patent Application Publication
(10) Pub. No.: US 2026/0018399 A1
(43) Pub. Date: Jan. 15, 2026

(54) Ion Detector and Mass Spectrometer

(71) Applicant: SHIMADZU CORPORATION, Kyoto-shi (JP)

(72) Inventors: Yohei TOJI, Kyoto-shi (JP); Masaru NISHIGUCHI, Kyoto-shi (JP); Koichi KIMURA, Kyoto-shi (JP); Ririko NAKAOKA, Kyoto-shi (JP)

(21) Appl. No.: 19/264,754

(22) Filed: Jul. 9, 2025

(30) Foreign Application Priority Data
Jul. 10, 2024 (JP) 2024-111336

(51) Int. Cl. H01J 49/02; H01J 49/24; H01J 49/42

(52) U.S. Cl. CPC H01J 49/025; H01J 49/24; H01J 49/4215

(57) ABSTRACT

An ion detector (24) comprises a conversion dynode (241), a secondary electron multiplier tube (242), and a DC voltage application unit (243) that applies a DC voltage between the conversion dynode (241) and the secondary electron multiplier tube (242). A part or all of a surface of the conversion dynode (241), including an ion collision surface (2410) where ions collide, is made of a substance containing one or more elements selected from the group consisting of titanium, vanadium, and chromium at a higher density than iron and aluminum.

### TECHNICAL FIELD

The present invention relates to an ion detector and a mass spectrometer equipped with the ion detector.

### BACKGROUND ART

As one type of mass spectrometer, those using a quadrupole mass filter are known. A quadrupole mass filter has four rod-shaped electrodes, and by controlling the voltage applied to these electrodes, it allows only ions having a specific m/z (mass-to-charge ratio) among the ions generated from the sample to be analyzed to pass through. Then, by changing this frequency or amplitude over time, the m/z of the ions passing through the quadrupole mass filter is changed over time. By sequentially detecting the ions that have passed through the quadrupole mass filter in this manner with an ion detector, a mass spectrum showing the relationship between m/z and the ion detection intensity is obtained.

One type of ion detector used in such mass spectrometers includes a conversion dynode and a secondary electron multiplier tube (see, for example, Patent Document 1). A conversion dynode emits secondary particles having a charge of opposite polarity to the primary ions when primary ions, which are the ions to be detected, collide with it. When the primary ions are positive ions, the secondary particles are electrons or negative ions, and when the primary ions are negative ions, the secondary particles are positive ions. A secondary electron multiplier tube has a plurality of dynodes connected, and when an ion or electron collides with the first dynode, multiple electrons are emitted. When each of these multiple electrons collides with the second dynode, multiple electrons are further emitted, and by repeating this operation, a large number of electrons are generated. The large number of electrons thus generated are detected as an electric current.

In this ion detector, the secondary electron multiplier tube is provided at a position off the optical axis of the incident ions, and the conversion dynode is disposed at a position facing the secondary electron multiplier tube across the optical axis. A negative potential of a predetermined magnitude is constantly applied to the secondary electron multiplier tube, and a DC voltage of an appropriate magnitude according to the polarity of the primary ions to be detected is applied between the conversion dynode and the secondary electron multiplier tube. That is, when detecting positive ions, a DC voltage is applied such that the conversion dynode side is negative and has a lower (larger absolute value) potential than the secondary electron multiplier tube side, and when detecting negative ions, a DC voltage is applied such that the conversion dynode side is positive. As a result, a force is applied to the primary ions toward the conversion dynode side. Then, the primary ions are accelerated by the DC voltage and collide with the conversion dynode, and the secondary particles emitted thereby are accelerated by the DC voltage in the opposite direction to the primary ions and enter the secondary electron multiplier tube. This allows the primary ions that have passed through the quadrupole mass filter to collide with the conversion dynode without escaping, and also allows the secondary particles emitted from the conversion dynode to be efficiently collected by the secondary electron multiplier tube, thereby improving detection sensitivity.

### PRIOR ART DOCUMENTS

### Patent Documents

Patent Document 1: JP 2013-254668 A

### Non-Patent Documents

Non-Patent Document 1: Ishikawa, Makishi, “Secondary Ion Mass Spectrometry (SIMS)—Focusing on Overview and Recent Application Examples—”, News of Central Analysis Center, Kyushu University, published by Central Analysis Center, Kyushu University, No. 103, pp. 1-6, published Jan. 31, 2009.

### SUMMARY OF THE INVENTION

### Problem to be Solved by the Invention

In recent years, quantitative analysis of PFAS and haloacetic acids contained in the environment and food has been performed to investigate their effects on the human body, as these substances are suspected carcinogens. PFAS is a general term for Per-fluoroalkyl and Polyfluoroalkyl Substances, which are used in a wide range of fields such as water and oil repellents, surfactants, foam fire extinguishing agents, and coating agents for cooking utensils. Haloacetic acids are by-products generated during the disinfection of tap water. Mass spectrometers are used as a means of quantifying these PFAS and haloacetic acids with high sensitivity. In a mass spectrometer, PFAS and haloacetic acids are ionized into negative ions in an ionization unit. However, in ion detectors equipped with the aforementioned conversion dynode and secondary electron multiplier tube, generally, the number of secondary particles emitted from the conversion dynode is smaller when the primary ions to be detected are negative ions than when they are positive ions. Therefore, with mass spectrometers using such conventional ion detectors, components that are ionized into negative ions, such as PFAS and haloacetic acids, cannot be quantified with high sensitivity.

An object of the present invention is to provide an ion detector capable of quantifying ionized components with high sensitivity regardless of the polarity of the ions, and a mass spectrometer equipped with the ion detector.

### Means for Solving the Problem

An ion detector according to the present invention, made to solve the above problems, comprises:
a conversion dynode, a secondary electron multiplier tube, and a DC voltage application unit that applies a DC voltage between the conversion dynode and the secondary electron multiplier tube,
wherein a part or all of the surface of the conversion dynode, including an ion collision surface where ions collide, is made of a substance containing one or more elements selected from titanium, vanadium, and chromium at a higher density than iron and aluminum.

A mass spectrometer according to the present invention comprises:
an ionization unit that ionizes a substance to be analyzed;
an ion selection unit that selects and emits ions having a specific m/z from among the ions ionized by the ionization unit; and
the ion detector, disposed downstream of the ion selection unit.

### Effects of the Invention

Titanium, vanadium, and chromium have the characteristic of producing a larger number of secondary positive ions when primary negative ions collide with them, compared to stainless steel (main constituent element is iron (Fe)) or aluminum, which are conventionally used as materials for conversion dynodes in ion detectors. In the ion detector and mass spectrometer according to the present invention, a part or all of the surface of the conversion dynode, including the ion collision surface where (primary) ions collide, is made of a substance containing one or more elements selected from titanium, vanadium, and chromium, which have the above characteristic, at a higher density than iron and aluminum. This enables high-sensitivity quantification of not only positive ions but also negative ions, i.e., regardless of the polarity of the ions. In particular, components that are ionized into negative ions, such as PFAS and haloacetic acids, which were conventionally difficult to quantify with high sensitivity, can be quantified with high sensitivity.

### BRIEF DESCRIPTION OF THE DRAWINGS

FIG. 1 is a schematic configuration diagram of a mass spectrometer according to the present invention.

FIG. 2 is a longitudinal sectional view of a conversion dynode included in the mass spectrometer of the present embodiment.

FIG. 3 is a graph showing the results of an experiment to determine the detection sensitivity of negative ions generated by fragmentation of perfluorooctanesulfonic acid (PFOS) for the mass spectrometer of the present embodiment and two conventional examples.

FIG. 4 is a graph showing the results of an experiment to determine the detection sensitivity of positive ions generated by fragmentation of reserpine for the mass spectrometer of the present embodiment and a conventional example.

FIG. 5 is a longitudinal sectional view of a conversion dynode included in a mass spectrometer of a modified example.

### DETAILED DESCRIPTION OF EMBODIMENTS

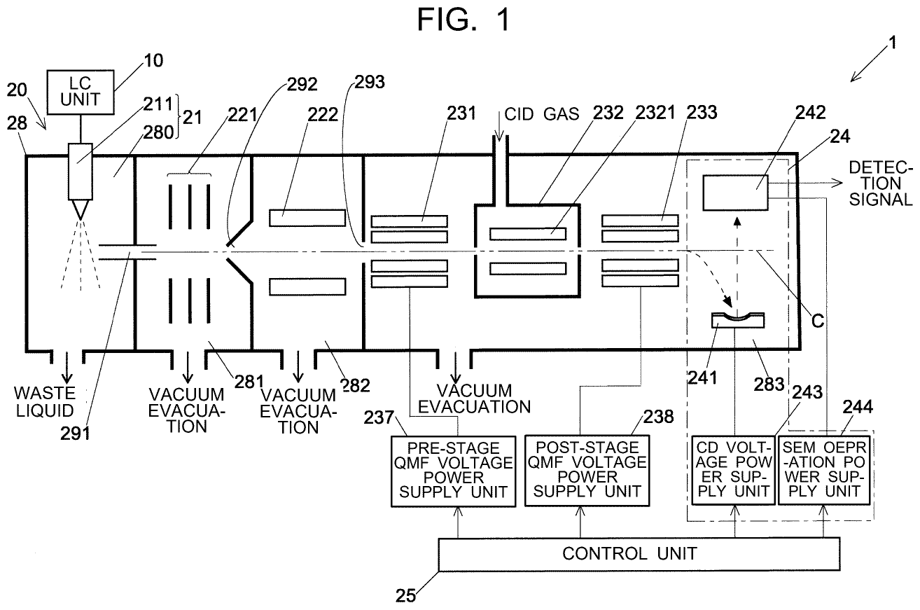

An embodiment of a mass spectrometer according to the present invention will be described with reference to FIGS. 1 to 4.

### (1) Configuration of the Mass Spectrometer of the Present Embodiment

The mass spectrometer 1 of the present embodiment is an LC-MS having a liquid chromatograph (LC) unit 10 upstream of a mass spectrometry (MS) unit 20, as shown in FIG. 1. The LC unit 10 temporally separates components contained in a liquid sample by a column (not shown) and sends them to the MS unit 20 for each component.

The MS unit 20 has a chamber 28 provided with an ionization chamber 280, a first intermediate vacuum chamber 281, a second intermediate vacuum chamber 282, and a high vacuum chamber 283. The interior of the ionization chamber 280 is at approximately atmospheric pressure, and differential pumping is performed by a vacuum pump (not shown) so that the degree of vacuum gradually increases from the ionization chamber 280 to the high vacuum chamber 283.

The ionization chamber 280 is provided with an electrospray ionization (ESI) nozzle 211 that sprays the liquid sample sent from the LC unit 10 while generating a high electric field in the chamber. Charged droplets are generated by this spray, and compounds in the droplets are ionized in the process of the droplets splitting and the solvent evaporating. The ionization chamber 280 and the ESI nozzle 211 constitute an ionization unit 21.

A heated capillary 291 that heats ions in the ionization chamber and allows them to pass toward the first intermediate vacuum chamber 281 is provided between the ionization chamber 280 and the first intermediate vacuum chamber 281. Further, a first ion guide 221 is provided in the first intermediate vacuum chamber 281, and a second ion guide 222 is provided in the second intermediate vacuum chamber 282, and a skimmer 292 is provided between the first intermediate vacuum chamber 281 and the second intermediate vacuum chamber 282. Ions are focused onto an ion optical axis C by these first ion guide 221 and second ion guide 222, and are introduced into the high vacuum chamber 283 through an orifice 293 provided between the second intermediate vacuum chamber 282 and the high vacuum chamber 283.

Inside the high vacuum chamber 283, a pre-stage quadrupole mass filter 231, a collision cell 232, a post-stage quadrupole mass filter 233, and an ion detector 24 are provided in this order from the orifice 293 side. The pre-stage quadrupole mass filter 231 and the post-stage quadrupole mass filter 233 correspond to the ion selection unit described above.

Both the pre-stage quadrupole mass filter 231 and the post-stage quadrupole mass filter 233 have four rod-shaped electrodes, and voltages are applied between the rod-shaped electrodes from a pre-stage QMF voltage power supply unit 237 and a post-stage QMF voltage power supply unit 238, respectively. A quadrupole ion guide 2321 is disposed inside the collision cell 232. Also, a collision-induced dissociation (CID) gas is introduced into the collision cell 232.

The ion detector 24 includes a conversion dynode (CD) 241, a secondary electron multiplier (SEM) tube 242, a CD voltage power supply unit 243, and an SEM operation power supply unit 244. The CD 241 and the SEM 242 are disposed across the ion optical axis C.

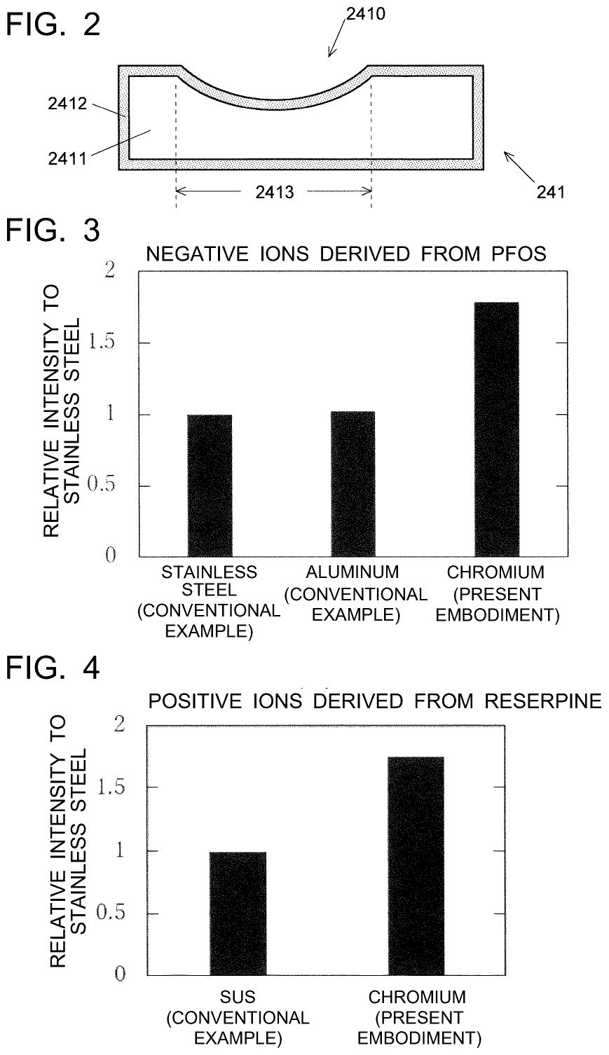

As shown in FIG. 2, the CD 241 has a substrate 2411 and a surface layer 2412 formed on the surface of the substrate 2411.

In the present embodiment, the substrate 2411 is made of a material containing 90% or more of aluminum (Al) because it is easy to machine. Instead of Al, a substrate made of another material such as stainless steel (main constituent element is iron (Fe)) may be used.

In the present embodiment, the surface layer 2412 is formed by applying chromium (Cr) plating to the surface of the substrate 2411, and its main component is Cr oxide (Cr₂O₃). The surface layer 2412, whose main component is Cr₂O₃ as described above, has the advantage of being easily formed on the surface of the substrate 2411 made of Al or stainless steel by a wet plating method.

Although general stainless steel also contains a small amount of chromium, the content density of chromium in stainless steel is sufficiently lower than the content density of iron. In contrast, in the surface layer 2412 of the CD 241 in the mass spectrometer 1 of the present embodiment, iron is hardly contained (although it may be slightly contained as an impurity), and the content density of chromium is sufficiently higher than the content density of iron. Similarly, aluminum is hardly contained in the surface layer 2412, and the content density of chromium is sufficiently higher than the content density of aluminum.

The material of the surface layer 2412 is not limited to this example, and may be, for example, simple Cr, a Cr compound other than an oxide, simple Ti and its compounds, simple V and its compounds, or an alloy of two or three of Ti, V, and Cr, or a compound of these two or three elements with other elements. That is, the material of the surface layer 2412 only needs to contain one or more of Ti, V, and Cr. Note that the surface layer 2412 containing Ti and/or V as a main component cannot be produced by a wet plating method, and is produced using a method such as a CVD method or a sputtering method.

The surface layer 2412 containing only Cr and not Ti and Vis preferable in that it can be easily produced using a wet plating method.

Since the surface layer 2412 is gradually sputtered during use of the mass spectrometer 1 (during detection of negative ions), it is desirable that the initial surface layer 2412 has a certain thickness, specifically a thickness of 0.1 μm or more. In the present embodiment, the thickness of the surface layer 2412 was set to 0.5 μm. In the present embodiment, the surface layer 2412 was provided on the entire surface of the substrate 2411 due to the use of the wet plating method for production. However, it is not necessary to provide the surface layer 2412 on other parts of the surface as long as the surface layer 2412 is provided on the ion collision surface 2410 where primary ions collide, among the surfaces of the substrate 2411.

The CD voltage power supply unit 243 is a power supply that applies a DC voltage (hereinafter referred to as “CD voltage”) between the CD 241 and the SEM 242. When the ions emitted from the post-stage quadrupole mass filter 233 are negative ions, a DC voltage is applied so that the CD 241 side is positive and the SEM 242 side is negative. By setting the polarity of the CD voltage so that the CD 241 side is positive in this way, an electric field is formed from the CD 241 toward the SEM 242. Thereby, the negative ions emitted from the post-stage quadrupole mass filter 233 head toward the CD 241 side as primary ions, and the positive ions emitted from the surface layer 2412 head toward the SEM 242 side as secondary particles. On the other hand, when the ions emitted from the post-stage quadrupole mass filter 233 are positive ions, the CD voltage power supply unit 243 applies a CD voltage between the CD 241 and the SEM 242 such that both the CD 241 and the SEM 242 are at a negative potential and the CD 241 side is at a lower potential than the SEM 242, thereby forming an electric field from the SEM 242 toward the CD 241. Thereby, the positive ions emitted from the post-stage quadrupole mass filter 233 head toward the CD 241 side as primary ions, and negative ions or electrons are emitted from the surface layer 2412 as secondary particles and enter the SEM 242.

A recess 2413 is provided in a part of the ion collision surface 2410 of the CD 241. By forming such a recess 2413, an equipotential surface is formed between the CD 241 and the SEM 242 such that the CD 241 side is convex and the SEM 242 side is concave. When primary ions enter this surface, secondary particles are emitted and fly in a direction perpendicular to the equipotential surface. This allows the secondary particles to be focused and enter the SEM 242.

The SEM 242 is the same as that conventionally used in ion detectors, and thus detailed description thereof is omitted. The SEM operation power supply unit 244 is a power supply for supplying power to operate the SEM 242.

The pre-stage QMF voltage power supply unit 237, the post-stage QMF voltage power supply unit 238, the CD voltage power supply unit 243, and the SEM operation power supply unit 244 are controlled by a control unit 25. The control unit 25 is embodied by hardware such as a CPU and memory, and software.

### (2) Operation of the Mass Spectrometer of the Present Embodiment

Next, the analysis operation by the mass spectrometer 1 of the present embodiment will be described. A liquid sample to be analyzed is temporally separated into its constituent components in the LC unit 10, introduced into the ESI nozzle 211 of the ionization unit 21 for each component, and ionized into positive ions or negative ions for each component in the ionization unit 21. These ions pass through the first ion guide 221 and the second ion guide 222 and are introduced into the pre-stage quadrupole mass filter 231.

The pre-stage quadrupole mass filter 231 allows only ions having an m/z corresponding to the voltage applied between the rod-shaped electrodes by the pre-stage QMF voltage power supply unit 237 to pass through from among the introduced ions. In the collision cell 232, the ions that have passed through the pre-stage quadrupole mass filter 231 are fragmented by colliding with molecules of CID gas. The post-stage quadrupole mass filter 233 allows only ions having an m/z corresponding to the voltage applied between the rod-shaped electrodes by the post-stage QMF voltage power supply unit 238 to pass through from among the ions fragmented in the collision cell 232. By changing the voltage applied here, the m/z of the ions passing through the post-stage quadrupole mass filter 233 sequentially changes, and these ions are sequentially detected by the ion detector 24 as described below, whereby a mass spectrum is obtained.

In the ion detector 24, a CD voltage is applied between the CD 241 and the SEM 242 as described above. If the ions emitted from the post-stage quadrupole mass filter 233 are negative ions, the negative ions are subjected to a force from the electric field formed by the CD voltage, where the CD 241 side is positive and the SEM 242 side is negative, and head toward the CD 241 side, colliding with the surface of the CD 241. Thereby, positive ions are emitted as secondary particles from the surface of the CD 241. The emitted positive ions are subjected to a force from the electric field and head toward the SEM 242 side, entering the SEM 242 and being detected. If the ions emitted from the post-stage quadrupole mass filter 233 are positive ions, they are subjected to a force from the electric field formed by the CD voltage, where both the CD 241 and the SEM 242 are at a negative potential and the CD 241 side is at a lower potential than the SEM 242, and head toward the CD 241 side, colliding with the surface of the CD 241. Thereby, negative ions or electrons are emitted as secondary particles from the surface of the CD 241 and enter the SEM 242. Here, whether the ions emitted from the post-stage quadrupole mass filter 233 are negative ions or positive ions, the recess 2413 formed on the surface of the CD 241 facing the ion optical axis C allows the secondary particles emitted from the surface of the CD 241 to be focused and enter the SEM 242.

### (3) Effects of the Mass Spectrometer of the Present Embodiment

To explain the effects of the mass spectrometer 1 of the present embodiment, first, an example (Non-Patent Document 1) in which the intensity (number) of positive ions emitted as secondary ions when negative ions as primary ions collide with various targets made of mutually different constituent elements was measured will be described. In this example, as primary ions, an ion beam of O-, which is a monovalent oxygen ion, with an energy of 13.5 keV is irradiated onto the target. Reading the positive ion emission intensity for the main constituent elements of the target from the figure described in Non-Patent Document 1, the results are as shown in the following table.

TABLE 1

| Constituent Element | Secondary Ion Intensity | |
|---|---|---|
| of Target | (Count / 10⁻⁹ C) | Remarks |
| Al | ~7 × 10⁵ | Conventional Example |
| Fe | ~4 × 10⁵ | Conventional Example |
| Ti | ~2 × 10⁶ | Present Embodiment |
| V | ~2 × 10⁶ | Present Embodiment |
| Cr | ~2 × 10⁶ | Present Embodiment |
| Mg | ~5 × 10⁵ | Comparative Example |
| Si | ~5 × 10⁵ | Comparative Example |
| Mn | ~7 × 10⁵ | Comparative Example |
| Cc | ~1 × 10⁵ | Comparative Example |
| Ni | ~7 × 10⁴ | Comparative Example |
| Cu | ~7 × 10⁴ | Comparative Example |
| Zn | ~2 × 10⁴ | Comparative Example |

Thus, when the constituent element of the target is any of Ti, V, and Cr, positive ions, which are secondary ions, are obtained with a higher intensity (approximately 3 to 5 times) than in the case of Al or Fe (main constituent element of stainless steel), which are materials used in conventional CDs. Note that for each constituent element listed as a comparative example in the table above, the intensity of secondary ions is about the same as in the case of Al (in the case of manganese (Mn)) or smaller than Al (in the cases of magnesium (Mg), silicon (Si), cobalt (Co), nickel (Ni), copper (Cu), and zinc (Zn)).

According to the mass spectrometer 1 of the present embodiment, at least the portion of the surface of the CD 241 facing the ion optical axis C is the surface layer 2412 containing Cr, which has a higher emission intensity of positive secondary ions than conventional Al or stainless steel (Fe) as described above. This allows for a larger number of positive ions to be generated when negative ions collide, compared to conventional CDs made entirely of Al or stainless steel. As a result, the detection sensitivity of negative ions in the ion detector 24 can be increased, enabling high-sensitivity quantification of components such as PFAS and haloacetic acids that are ionized into negative ions in the ionization unit 21.

This effect is achieved not only when the surface layer 2412 is mainly composed of Cr oxide as in the present embodiment, but also when it is made of simple Cr or a Cr compound other than an oxide. Further, the above effect is similarly achieved when the main component of the surface layer 2412 is simple Ti or V, or their compounds, which have an emission intensity of positive secondary ions equivalent to that of Cr, or an alloy or compound in which two or three of Ti, V, and Cr are mixed.

Next, the results of an experiment to measure the detection intensity of negative ions for the mass spectrometer 1 of the present embodiment and two conventional examples of mass spectrometers having the same configuration as the present embodiment except that they use conventional CDs made only of Al or stainless steel will be shown. In this experiment, a sample containing perfluorooctanesulfonic acid (PFOS, molecular weight 500.13), which is a type of PFAS, was introduced into each of the mass spectrometers of the present embodiment and the two conventional examples at the same concentration and in the same amount, and negative ions (m/z=80) generated by fragmenting PFOS were detected by the ion detector. The experimental results are shown in FIG. 3.

Assuming that the detection sensitivity of the conventional example using a CD made only of stainless steel is 1, the detection sensitivity of the conventional example using a CD made only of Al is approximately 1, which is about the same as in the case of stainless steel, whereas in the present embodiment, the detection sensitivity was approximately 1.8. Thus, the mass spectrometer 1 of the present embodiment can detect negative ions of PFOS with a detection sensitivity approximately 1.8 times higher than the two conventional examples. Although an experiment was conducted using PFOS as an example here, it is considered that the present embodiment also improves the detection sensitivity compared to the two conventional examples when measuring substances other than PFOS, such as other PFAS or haloacetic acids that generate negative ions.

Next, the results of an experiment to measure the detection intensity of positive ions for the mass spectrometer 1 of the present embodiment and a conventional example of a mass spectrometer using a conventional CD made only of stainless steel will be shown. In this experiment, positive ions (m/z=197) generated by fragmenting reserpine (molecular weight 608.68), which is a drug used as a tranquilizer and antihypertensive agent, were detected by the ion detector for each of the mass spectrometers of the present embodiment and the conventional example. The experimental results are shown in FIG. 4. Assuming that the detection sensitivity of the conventional example using a CD made only of stainless steel is 1, the detection sensitivity in the present embodiment was approximately 1.8. Thus, the mass spectrometer 1 of the present embodiment can increase the detection sensitivity not only for negative ions but also for positive ions compared to the conventional mass spectrometer.

As described above, experimental results showing that the detection sensitivity of negative and positive ions is improved compared to conventional examples when the surface layer 2412 is mainly composed of chromium oxide have been presented. However, it is considered that the detection sensitivity of negative and positive ions is similarly improved when simple Cr or a compound of Cr other than an oxide, or simple Ti or V or their compounds, is used as the material of the surface layer 2412.

### (4) Modified Examples

The present invention is not limited to the above embodiment, and various modifications are possible.

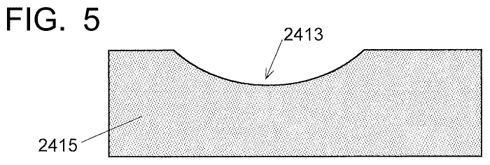

For example, in the above embodiment, the CD 241, in which the surface layer 2412 containing one or more elements selected from Ti, V, and Cr is provided near the surface of the substrate 2411 made of Al, stainless steel, or the like, was used. However, instead of this, as shown in FIG. 5, a CD 2415 made entirely of a material containing one or more elements selected from Ti, V, and Cr may be used.

In the above embodiment, the recess 2413 was provided on the surface of the CD 241 facing the ion optical axis C, but the recess 2413 may be omitted.

In the above embodiment, a quadrupole mass filter (pre-stage quadrupole mass filter 231, post-stage quadrupole mass filter 233) was used as the ion selection unit, but a mass filter having a different configuration may be used. Further, instead of a mass filter, an ion trap such as a three-dimensional quadrupole ion trap composed of a ring electrode and two end cap electrodes, or a linear ion trap composed of four (or more) electrodes may be used.

The mass spectrometer 1 according to the above embodiment is an LC-MS combining the MS unit 20 and the LC unit 10, but the present invention can also be applied to a GC-MS combining an MS unit and a gas chromatograph (GC), or a standalone mass spectrometer not combined with a chromatograph (LC, GC). Further, the configuration of the MS unit 20 is not limited to the one described above, and any MS unit having an ionization unit, an ion selection unit (mass filter, ion trap), and an ion detector using a conversion dynode and a secondary electron multiplier tube can be used. For example, the ionization unit is not limited to the one using the ESI method in the present embodiment, and one using any ionization method can be applied.

### [Aspects]

It will be apparent to those skilled in the art that the exemplary embodiments described above are specific examples of the following aspects.

(Item 1) An ion detector according to one aspect of the present invention comprises: a conversion dynode, a secondary electron multiplier tube, and a DC voltage application unit that applies a DC voltage between the conversion dynode and the secondary electron multiplier tube,

wherein a part or all of the surface of the conversion dynode, including an ion collision surface where ions collide, is made of a substance containing one or more elements selected from titanium (Ti), vanadium (V), and chromium (Cr) at a higher density than iron and aluminum.

(Item 6) A mass spectrometer according to one aspect of the present invention comprises:
an ionization unit that ionizes a substance to be analyzed;
an ion selection unit that selects and emits ions having a specific m/z from among the ions ionized by the ionization unit; and
the ion detector according to any one of Items 1 to 5 (Items 2 to 5 will be described later), disposed downstream of the ion selection unit.

Non-Patent Document 1 shows experimental results in which the relative intensity of secondary ions (value obtained by dividing the number of detected secondary ions by the number of atoms sputtered by irradiation of the ion beam) generated when an ion beam composed of O-ions (monovalent negative oxygen ions) as primary ions is irradiated onto various targets made of mutually different elements at a specific intensity (13.5 keV) was determined. According to these experimental results, the relative intensity of secondary ions for targets whose constituent elements are titanium, vanadium, and chromium, respectively, is higher than the relative intensity of secondary ions for targets whose constituent elements are iron and aluminum, respectively.

From these experimental results, titanium, vanadium, and chromium have the characteristic of producing a larger number of secondary positive ions when primary negative ions collide with them, compared to stainless steel (main constituent element is Fe) or aluminum, which are conventionally used as materials for conversion dynodes in ion detectors. In the ion detector according to Item 1 and the mass spectrometer according to Item 6, the portion of the surface of the conversion dynode where primary ions collide, which is the portion facing the optical axis or the secondary electron multiplier tube, is made of a substance containing one or more elements selected from titanium, vanadium, and chromium, which have the above characteristic, at a higher density than iron and aluminum. This enables high-sensitivity quantification of not only positive ions but also negative ions, i.e., regardless of the polarity of the ions. In particular, components that are ionized into negative ions, such as PFAS and haloacetic acids, which were conventionally difficult to quantify with high sensitivity, can be quantified with high sensitivity.

Titanium, vanadium, and/or chromium may exist as a simple substance in the portion where the primary ions collide, or may exist as a compound such as an oxide.

As the ion selection unit, a mass filter such as a quadrupole mass filter, an ion trap such as a quadrupole ion trap, or the like can be used. Further, the ion selection unit used in the present invention only needs to be capable of selecting and emitting at least negative ions having a specific m/z, and may also be capable of emitting positive ions having a specific m/z in addition to negative ions. Note that for the ionization unit and the ion selection unit (mass filter, ion trap, etc.), those similar to those used in conventional mass spectrometers can be used.

(Item 2) The ion detector according to Item 2 is the ion detector according to Item 1, wherein the conversion dynode comprises a substrate made of a material different from the substance, and a surface layer made of the substance provided on a part or all of the surface of the substrate, and a part or all of the surface of the surface layer is the ion collision surface.

According to the ion detector of Item 2, while selecting a material for the substrate according to the overall shape, cost, etc. of the conversion dynode, by providing the surface layer made of the substance, the detection sensitivity of negative ions in the ion detector can be increased. As the substrate, for example, one made of stainless steel, aluminum, or the like can be used.

Note that since the surface layer is gradually sputtered by the incidence of primary ions during use, it is desirable that the surface layer has a certain thickness (for example, 0.1 um or more).

(Item 3) The ion detector according to Item 3 is the ion detector according to Item 2, wherein the substance is chromium oxide.

(Item 4) The ion detector according to Item 4 is the ion detector according to Item 3, wherein the surface layer is made of a plated film.

Among titanium, vanadium, and chromium, which are the constituent elements of the surface layer listed in Item 1, chromium can easily form a film on the surface of a metal by a wet plating method. In such a film, chromium exists in an oxidized state (usually Cr₂O₃, in which Cr is trivalent). That is, according to the ion detectors of Item 3 and Item 4, since the surface layer can be easily formed on the surface of the substrate by a plating method, a conversion dynode that is easy to manufacture can be used.

(Item 5) The ion detector according to Item 5 is the ion detector according to any one of Items 2 to 4, wherein the substrate is made of a material containing 90% or more of aluminum.

According to the ion detector of Item 5, by using a substrate made of a material containing 90% or more of aluminum, mechanical processing can be performed more easily during manufacturing than with a substrate made of stainless steel or the like.

### REFERENCE SIGNS LIST

1 . . . Mass spectrometer
10 . . . Liquid chromatograph (LC) unit
20 . . . Mass spectrometry (MS) unit
21 . . . Ionization unit
211 . . . Electrospray ionization (ESI) nozzle
221 . . . First ion guide
222 . . . Second ion guide
231 . . . Pre-stage quadrupole mass filter (part of ion selection unit)
232 . . . Collision cell
232 . . . Quadrupole ion guide
233 . . . Post-stage quadrupole mass filter (part of ion selection unit)
237 . . . Pre-stage QMF voltage power supply unit
238 . . . Post-stage QMF voltage power supply unit
24 . . . Ion detector
241, 2415 . . . Conversion dynode (CD)
2410 . . . Ion collision surface
2411 . . . Substrate
2412 . . . Surface layer
2413 . . . Recess
242 . . . Secondary electron multiplier (SEM) tube
243 . . . CD voltage power supply unit
244 . . . SEM operation power supply unit
25 . . . Control unit
28 . . . Chamber
280 . . . Ionization chamber
281 . . . First intermediate vacuum chamber
282 . . . Second intermediate vacuum chamber
283 . . . High vacuum chamber
291 . . . Heated capillary

292 . . . Skimmer

293 . . . Orifice
C . . . Ion optical axis

1. An ion detector, comprising:
a conversion dynode;
a secondary electron multiplier tube; and
a DC voltage application unit configured to apply a DC voltage between the conversion dynode and the secondary electron multiplier tube,
wherein a part or all of a surface of the conversion dynode, including an ion collision surface where ions collide, is made of a substance containing one or more elements selected from the group consisting of titanium, vanadium, and chromium at a higher density than iron and aluminum.

2. The ion detector according to claim 1, wherein the conversion dynode comprises a substrate made of a material different from the substance, and a surface layer made of the substance provided on a part or all of a surface of the substrate, and a part or all of a surface of the surface layer is the ion collision surface.

3. The ion detector according to claim 2, wherein the substance is chromium oxide.

4. The ion detector according to claim 3, wherein the surface layer comprises a plated film.

5. The ion detector according to claim 2, wherein the substrate is made of a material containing 90% or more of aluminum.

6. A mass spectrometer, comprising:
an ionization unit configured to ionize a substance to be analyzed;
an ion selection unit configured to select and emit ions having a specific m/z from among the ions ionized by the ionization unit; and
the ion detector according to claim 1, disposed downstream of the ion selection unit.
